(19) United States
(12) Patent Application Publication
(10) Pub. No.: US 2026/0359668 A1
(43) Pub. Date: Nov. 12, 2026

(54) ANALYSIS OF A KNOWLEDGE GRAPH USING A LARGE LANGUAGE MODEL

(71) Applicant: INTERNATIONAL BUSINESS MACHINES CORPORATION, ARMONK, NY (US)

(72) Inventors: Rishabh Chakrabarti, Kolkata (IN); Anupam Chakraborty, Bengaluru (IN); Jirí Petník, Praha (CZ); Miroslav Fokt, Prague (CZ)

(21) Appl. No.: 19/200,319

(22) Filed: May 6, 2025

(51) Int. Cl. G06N 5/022

(52) U.S. Cl. CPC G06N 5/022

(57) ABSTRACT

A very large knowledge graph is queried by using a Large Language Model (LLM) by selecting only relevant nodes and edges in the very large knowledge graph. Operations are performed to optimize a knowledge graph schema sent to the LLM to reduce token usage and improve query accuracy, wherein the very large knowledge graph is a knowledge graph that has more than a predetermined number of nodes and edges.

### BACKGROUND

Embodiments relate to a method, system, and computer program product for the analysis of a knowledge graph using a large language model.

Large language models (LLMs) are computational models designed to handle natural language processing (NLP) tasks, such as generating human-like text, and other types of tasks. LLMs learn to perform these tasks by analyzing statistical relationships within massive datasets of text during a training phase. Many LLMs are constructed using artificial neural networks based on a decoder-only transformer architecture, which is particularly effective for language-related applications. To adapt them for specific purposes, LLMs may be fine-tuned with targeted datasets or directed by using prompt engineering techniques.

A knowledge graph (KG) is a structured way of representing data as a network of interconnected entities and their relationships. The knowledge graphs use nodes to represent entities (such as, people, places, or objects) and edges (or relationships) to show connections between them. This allows for a semantic understanding of data. Knowledge graphs may be used to improve the answer to questions in certain applications.

### SUMMARY

Provided are a method, system, and computer program product in which a very large knowledge graph is queried by using a Large Language Model (LLM) by selecting only relevant nodes and edges in the very large knowledge graph. Operations are performed to optimize a knowledge graph schema sent to the LLM to reduce token usage and improve query accuracy, wherein the very large knowledge graph is a knowledge graph that has more than a predetermined number of nodes and edges.

In certain embodiments, the relevant nodes are selected from a Horizontally Scalable Knowledge Graph using the LLM, where only node names and attributes are passed to the LLM for efficient node selection and supporting vertex filtering from a very large graph by iterating over subsets of vertices.

In further embodiments, edges are filtered between selected nodes in a large graph database, wherein each pair of selected nodes is iteratively analyzed using the LLM to determine relevant edges based on a user query.

In additional embodiments, cypher queries are generated with selective attribute inclusion, by using a sub-graph derived from filtered nodes and edges to construct graph queries for question interpretation, query generation, and structured analysis.

In yet additional embodiments, operations are performed that enhance schema linking using external context, and leverage the LLM to incorporate relevant external information for generating more precise cypher queries.

In certain embodiments, operations are performed to support extremely large graphs through iterative filtering, wherein vertex filtering operates on subsets of the extremely large graphs instead of processing an entire schema at once.

In further embodiments, edge filtering is applied to selected node pairs and relationships between the selected node pairs.

### BRIEF DESCRIPTION OF THE DRAWINGS

Referring now to the drawings in which like reference numbers represent corresponding parts throughout:

FIG. 1 illustrates a computing environment, in accordance with certain embodiments.

FIG. 2 illustrates a block diagram that shows the organization of a graph database, in accordance with certain embodiments.

FIG. 3 illustrates a block diagram that shows a query and potential matches, in accordance with certain embodiments.

FIG. 4 illustrates a flowchart that shows exemplary operations, in accordance with certain embodiments.

FIG. 5 illustrates a flowchart that shows additional exemplary operations, in accordance with certain embodiments.

FIG. 6 illustrates a computing environment in which certain components may be implemented, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

A knowledge graph is a specialized database that organizes information as nodes (representing entities) and relationships (edges connecting nodes). Both nodes and relationships can have associated properties, enriching the data structure. Knowledge graphs are widely used for applications for analyzing social networks, building recommendation systems, and mapping supply chains. Certain embodiments leverage Large Language Models (LLMs) to explore and describe relationships between nodes in a knowledge graph. To perform this analysis, the knowledge graph's schema (comprising nodes, relationships, and their properties, but not the actual data) is passed to the LLM. The LLM generates graph queries in formats such as Cypher (e.g., for Neo4j graph database) or AQL (Arango Database Query Language), which are then executed on the graph database to produce answers.

There are many challenges with large knowledge graphs. For example, large knowledge graph schemas often exceed the context window of state-of-the-art LLMs, which typically range from 8K to 32K tokens (e.g., Mistral 8x7B supports up to 32K tokens). For instance, an exemplary graph with 31 vertex types and an average of 8 incoming and outgoing edge types (out of 18 possible edge types) consumes approximately 26,000 tokens. A client-scale graph with 270 entities could require up to 260,000 tokens, far exceeding LLM context limits. This leads to issues such as: Inability to fit the full schema within the LLM's context window; increased inference time and token-based costs; reduced answer quality due to recency bias, where the LLM prioritizes recent tokens and makes errors.

To address these challenges, certain embodiments employ graph algorithms like Depth-First Search (DFS) to extract only the necessary and sufficient nodes and properties based on the user's query. This reduces the number of tokens sent to the LLM, lowering costs, improving inference speed, and enhancing the accuracy of generated queries.

In a specific application, a knowledge graph represents real-world entities and their relationships for postmortem crime analysis. Entities include people, vehicles, bank accounts, places, phones, weapons, and institutions, with relationships defining their interconnections. Example queries for crime analysis include:
(a) What is the number, color, or make of the car driven by Person A?
(b) Who are the friends or family members of Person A possessing Weapon B?
(c) Who are the members of organizations where Person X is also a member?
(d) Where was Person X last Sunday, and who did they meet there?

Processing such a knowledge graph with LLMs is time-intensive due to the large schema size, which often exceeds the LLM's context window. Without optimization, generating Cypher queries from a large schema may be slow and may produce incorrect results. Certain embodiments address this by trimming the knowledge graph to include only the relevant nodes and relationships, improving efficiency and query accuracy.

To efficiently query a large knowledge graph, certain embodiments follow a structured approach, as detailed below:
(1) Entity Identification: Identify the nodes (entities) mentioned in the user's query. For example, the query “What is the number/color/make of the car driven by Person A?” extracts “Person” and “Car” as relevant nodes.
(2) Path Discovery: Use Depth-First Search (DFS) to find all paths in the knowledge graph between the identified entities (e.g., between “Person” and “Car”).
(3) Schema Reduction: Construct a smaller knowledge graph schema that includes only the nodes and relationships found in the identified paths.
(4) Query Generation: Send the reduced schema and the user's query to the LLM to generate a Cypher or AQL query.
(5) Query Execution: Execute the generated Cypher or AQL query on the graph database to retrieve the answer.

This approach ensures that only relevant context is sent to the LLM, improving the accuracy of the generated queries and reducing token usage, which may be advantageous in token-metered pricing models.

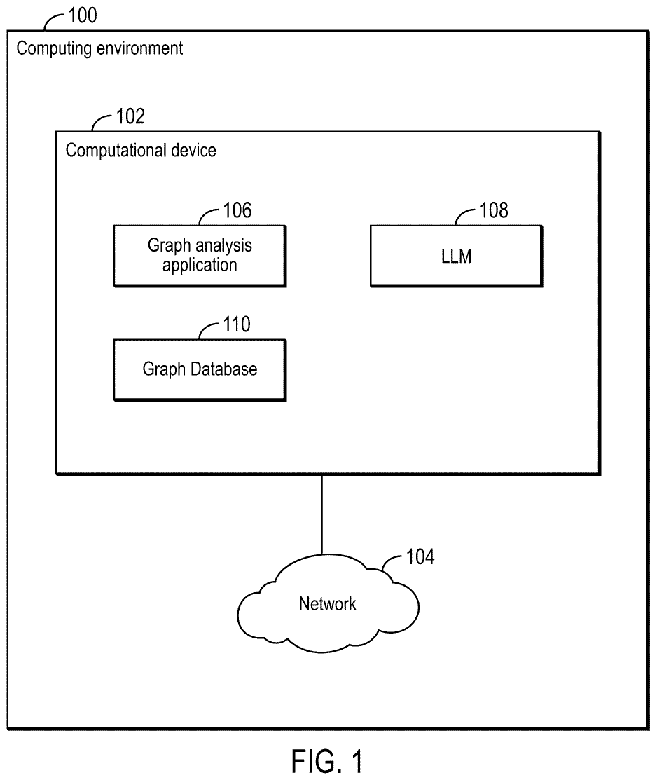

FIG. 1 illustrates a computing environment 100, in accordance with certain embodiments. At least one computational device 102 is coupled to a network 104 in the computing environment 100.

The computational device 102 executes a graph analysis application 106 that uses an LLM 108 and a graph database 110. In certain embodiments, the graph analysis application 106 and the LLM 108 may be implemented in hardware, firmware, software, or any combination thereof.

The computational device 102 may comprise any suitable computational device known in the art such as a server, a personal computer, a laptop, a mainframe, etc. The network 104 may comprise any suitable network known in the art such as the Internet, a local area network, a wide area network, etc. Adapters, routers, switches, etc., may couple the computational device 102 to the network 104.

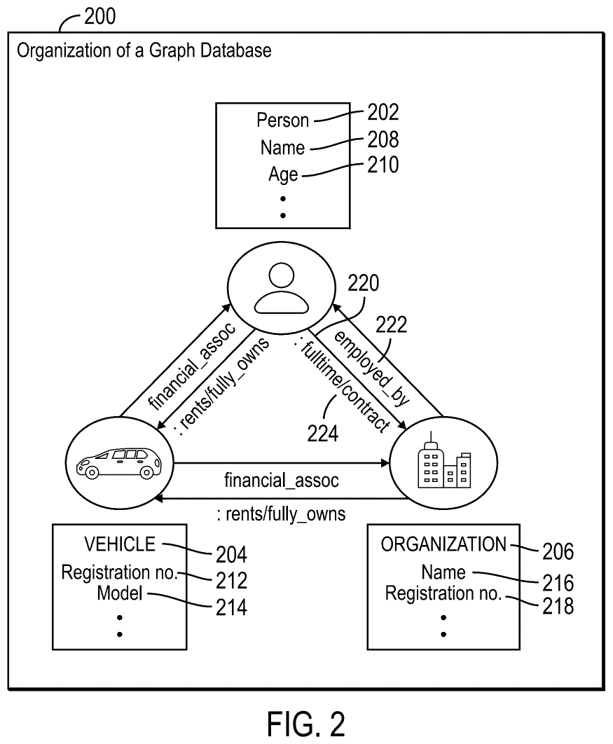

FIG. 2 illustrates a block diagram 200 that show the organization of a graph database, in accordance with certain embodiments.

The graph database is defined by vertices (nodes) and edges (relationships). Each vertex and edge can have multiple attributes, which enrich the graph's representation of entities and their relationships. For example, vertices may represent people, vehicles, or organizations, with edges indicating relationships such as ownership or affiliation. A sample graph may include vertices for a person, vehicle, and organization, with edges connecting them to represent real-world interactions.

In FIG. 2, three vertices (also referred to as nodes) are shown. The vertices are PERSON 202, VEHICLE 204 and ORGANIZATION 206. Each vertex may have one or more attributes. For example, PERSON 202 may have attributes of name 208 and age 210. The vertex VEHICLE 204 may have registration number 212 and model 214 as attributes. The vertex ORGANIZATION 206 may have Name 216 and Registration number 218 as attributes.

The edges connecting the vertices 202, 204, 206 may indicate relationships between vertices. For example, the edge 220 may indicate that a particular person is employed by (reference numeral 222) by a particular organization and also indicate via sub-attribute 224 whether the position is a full-time (“fulltime”) or contract (“contract”) position.

Given a graph G (V, E) with a large number of vertices (V) and edges (E), certain embodiments perform operations to:
(1) Fit the graph schema within the LLM's context window.
(2) Pass only relevant vertices and edges to the LLM.
(3) Generate accurate Cypher queries with the correct attributes.

The token consumption of a full-size graph is significant. For example, a graph with 31 vertex types and 8 edge types per vertex consumes approximately 26,000 tokens, while a client-scale graph with 270 entities could require 260,000 tokens. LLMs struggle to process such large graphs, and recency bias can cause errors in query generation.

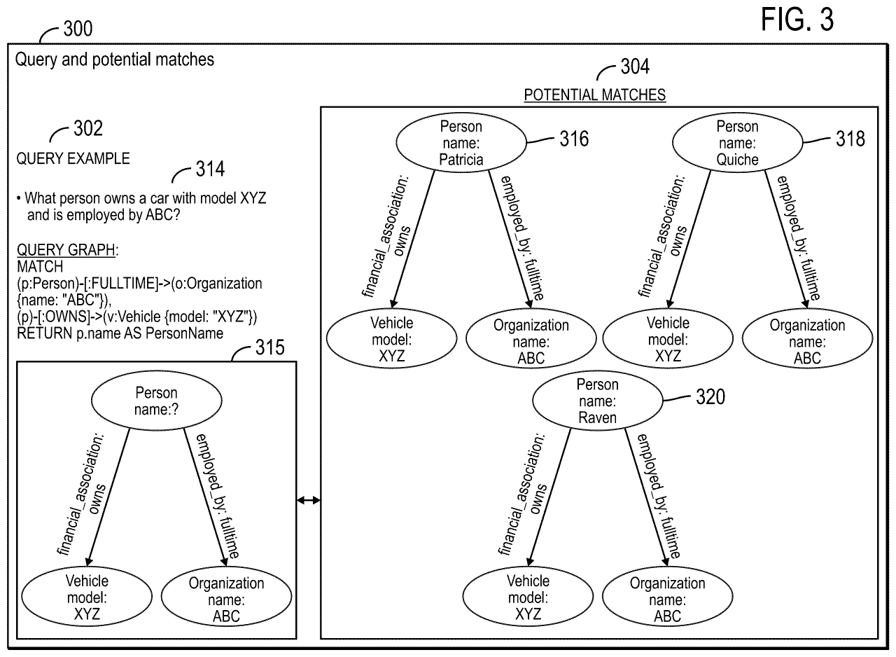

FIG. 3 illustrates a block diagram 300 that shows an example of query 302 and potential matches 304, in accordance with certain embodiments.

In certain embodiments, a sample query 314 may be as follows: “What person owns a car with model XYZ and is employed by ABC?”

In response to the above query whose query graph is shown via reference numeral 315, the system identifies potential matches by filtering relevant nodes and relationships as shown via reference numerals 316, 318, 320, in which the persons Patricia, Quiche, and Raven are identified as persons who own a XYZ and is employed by ABC.

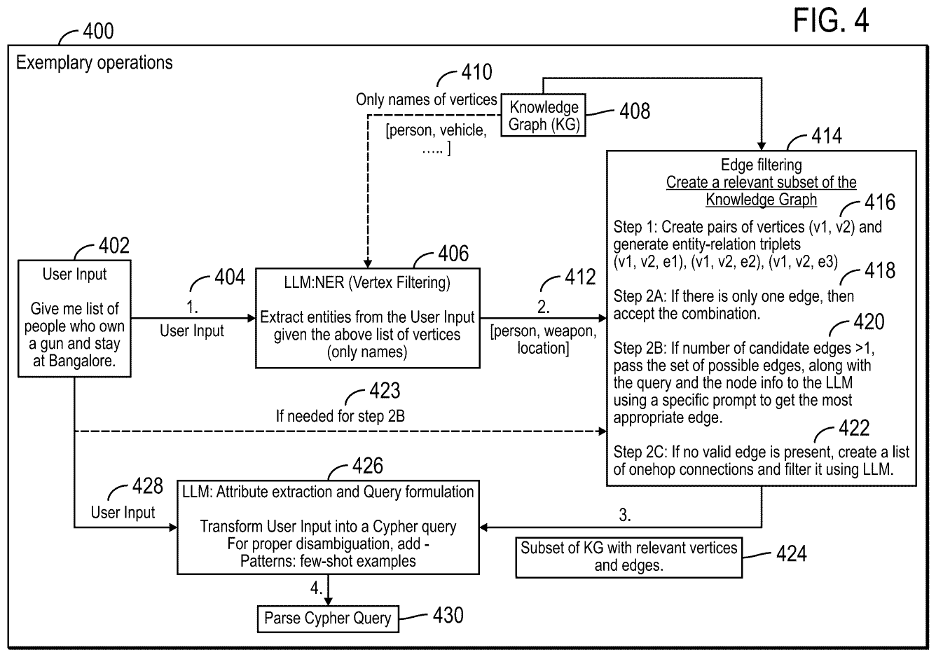

FIG. 4 illustrates a flowchart 400 that shows exemplary operations, in accordance with certain embodiments. The operations shown in FIG. 4 may be performed by the graph analysis application 106 in combination with the LLM 108 and the graph database 110 in the computational device 102 of the computing environment 100.

Control starts at block 402 in which a user input is provided. The user input may be in the form of a natural language. An example input is: “Give me a list of people who own a gun and stay at Bangalore.” The user input which is a query is provided to block 406 which is referred to as an LLM: Named Entity Recognition (NER) for vertex filtering that is performed by the LLM 108 (of FIG. 1).

Additionally, only names of vertices (e.g., persons, vehicles, etc.) are provided from a very large knowledge graph to block 406, as shown via reference numerals 408, 410.

In block 406, the vertex filtering operations extracts entities from the user's input query using a list of vertex names and transfers (reference numeral 412) the extracted entities to block 414 which performs edge filtering.

The operations performed in block 414 in edge filtering are as follows:
Step 1 (reference numeral 416): Create pairs of vertices (v1, v2) and generate entity-relation triplets, such as (v1, v2, e1), (v1, v2, e2), (v1, v2, e3).
Step 2A (reference numeral 418): If only one edge exists between the vertices, accept the combination.
Step 2B (reference numeral 420): If multiple candidate edges exist, pass the set of possible edges, the query, and node information to the LLM with a specific prompt to select the most appropriate edge.
Step 2C (reference numeral 422): If no valid edge exists, create a list of one-hop connections and filter it using the LLM.

If it is needed for performing step 2B the user input is also provided to block 414 (as shown via reference numeral 423).

From block 414 that performs a Schema Subset Construction, a reduced knowledge graph schema containing only the relevant vertices and edges are sent (reference numeral 424) as input to block 426 which also takes the user input (block 402) as shown via reference numeral 428.

Block 428 performs an LLM based Attribute Extraction and Query Formulation that transform the user's query into a Cypher query 430, incorporating relevant attributes.

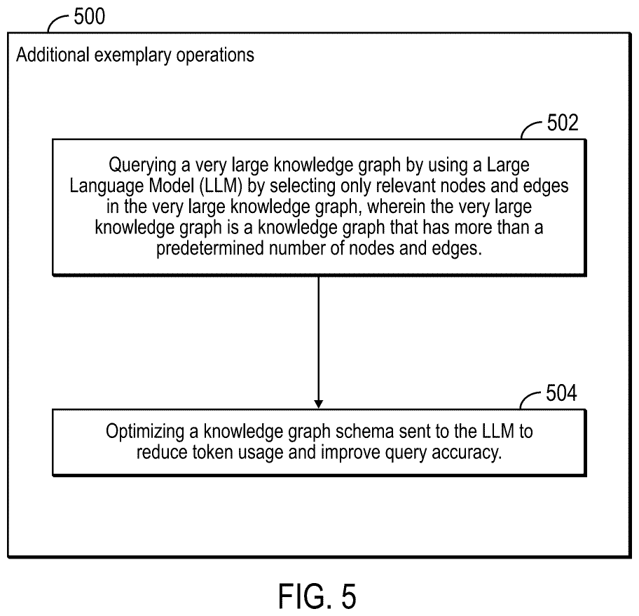

FIG. 5 illustrates a flowchart 500 that shows additional exemplary operations, in accordance with certain embodiments. The operations shown in FIG. 5 may be performed by the graph analysis application 106 in combination with the LLM 108 and the graph database 110 in the computational device 102 of the computing environment 100.

In FIG. 5, control starts at block 502 in which a very large knowledge graph is queried by using a Large Language Model (LLM) 108 by selecting only relevant nodes and edges in the very large knowledge graph that may be present in the graph database 110).

From block 502 control proceeds to block 504 in which operations are performed to optimize a knowledge graph schema sent to the LLM to reduce token usage and improve query accuracy, wherein the very large knowledge graph is a knowledge graph that has more than a predetermined number of nodes and edges. The predetermined number may be at least hundred or thousand or more.

This process ensures that complex question-answering from large knowledge graphs becomes feasible.

Certain embodiments enable efficient and accurate analysis of large knowledge graphs by integrating LLMs with graph algorithms like depth first search (DFS). By trimming the knowledge graph schema to include only relevant nodes and relationships, these embodiments reduce token usage, lower computational costs, and enhance the quality of generated queries. This approach is particularly valuable for applications like crime analysis or data analysis, where large, complex knowledge graphs must be queried to answer intricate questions about real-world entities and their relationships.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner that at least partially overlaps in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

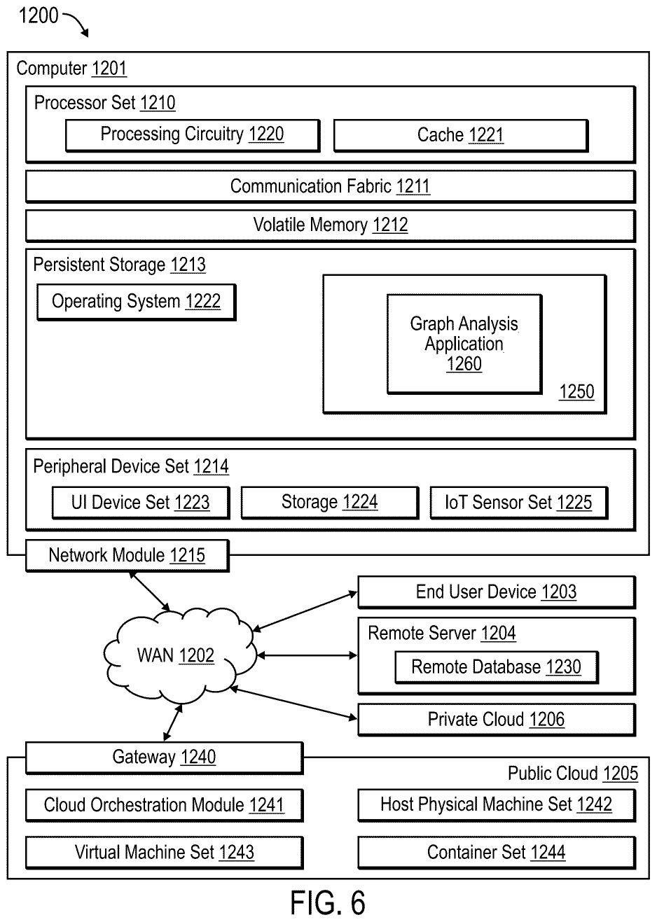

In FIG. 6, a computing environment 1200 contains an example of an environment for the execution of at least some of the computer code (block 1250) involved in performing the operations for a graph analysis application 1260 that performs operations shown in FIGS. 1-5.

In addition to block 1250, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 1250, as identified above), peripheral device set 1214 (including user interface (UI) device set 1223, storage 1224, and Internet of Things (IoT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible computer 1201 may be located in a cloud, even though it is not shown in a cloud in FIG. 6. On the other hand, computer 1201 is not required to be in a cloud except to any extent as may be affirmatively indicated.

PROCESSOR SET 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits and performing quantum computing.

Computer readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 1250 in persistent storage 1213.

COMMUNICATION FABRIC 1211 is the signal conduction path that allows the various components of computer 1201 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1212 is any type of volatile memory now known or to be developed in the future. Examples include dynamic type random access memory (RAM) or static type RAM. Typically, volatile memory 1212 is characterized by random access, but this is not required unless affirmatively indicated. In computer 1201, the volatile memory 1212 is located in a single package and is internal to computer 1201, but, alternatively or additionally, the volatile memory may be distributed over multiple packages and/or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may be a read only memory (ROM), but typically at least a portion of the persistent storage allows writing of data, deletion of data and re-writing of data. Some familiar forms of persistent storage include magnetic disks and solid-state storage devices. Operating system 1222 may take several forms, such as various known proprietary operating systems or open-source Portable Operating System Interface-type operating systems that employ a kernel. The code included in block 1250 typically includes at least some of the computer code involved in performing the inventive methods.

PERIPHERAL DEVICE SET 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1223 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In some embodiments, storage 1224 may take the form of a quantum computing storage device for storing data in the form of qubits. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. I/O T sensor set 1225 is made up of sensors that can be used in Internet of Things applications. For example, one sensor may be a thermometer, and another sensor may be a motion detector.

NETWORK MODULE 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN 1202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on.

REMOTE SERVER 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 1201 from remote database 1230 of remote server 1204.

PUBLIC CLOUD 1205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is similar to public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is

1. A method, comprising:
querying a very large knowledge graph by using a Large Language Model (LLM) by selecting only relevant nodes and edges in the very large knowledge graph; and
optimizing a knowledge graph schema sent to the LLM to reduce token usage and improve query accuracy, wherein the very large knowledge graph is a knowledge graph that has more than a predetermined number of nodes and edges.

2. The method of claim 1, the method further comprising:
selecting the relevant nodes from a Horizontally Scalable Knowledge Graph using the LLM, where only node names and attributes are passed to the LLM for efficient node selection and supporting vertex filtering from a very large graph by iterating over subsets of vertices.

3. The method of claim 1, the method further comprising:
filtering edges between selected nodes in a large graph database, wherein each pair of selected nodes is iteratively analyzed using the LLM to determine relevant edges based on a user query.

4. The method of claim 1, the method further comprising:
generating cypher queries with selective attribute inclusion, by using a sub-graph derived from filtered nodes and edges to construct graph queries for question interpretation, query generation, and structured analysis.

5. The method of claim 1, the method further comprising:
enhancing schema linking using external context, and leveraging the LLM to incorporate relevant external information for generating more precise cypher queries.

6. The method of claim 1, the method further comprising:
supporting extremely large graphs through iterative filtering, wherein vertex filtering operates on subsets of the extremely large graphs instead of processing an entire schema at once.

7. The method of claim 6, wherein edge filtering is applied to selected node pairs and relationships between the selected node pairs.

8. A system, comprising:
a memory; and
a processor coupled to the memory, wherein the processor performs operations, the operations comprising:
querying a very large knowledge graph by using a Large Language Model (LLM) by selecting only relevant nodes and edges in the very large knowledge graph; and
optimizing a knowledge graph schema sent to the LLM to reduce token usage and improve query accuracy, wherein the very large knowledge graph is a knowledge graph that has more than a predetermined number of nodes and edges.

9. The system of claim 8, the operations further comprising:
selecting the relevant nodes from a Horizontally Scalable Knowledge Graph using the LLM, where only node names and attributes are passed to the LLM for efficient node selection and supporting vertex filtering from a very large graph by iterating over subsets of vertices.

10. The system of claim 8, the operations further comprising:
filtering edges between selected nodes in a large graph database, wherein each pair of selected nodes is iteratively analyzed using the LLM to determine relevant edges based on a user query.

11. The system of claim 8, the operations further comprising:
generating cypher queries with selective attribute inclusion, by using a sub-graph derived from filtered nodes and edges to construct graph queries for question interpretation, query generation, and structured analysis.

12. The system of claim 8, the operations further comprising:
enhancing schema linking using external context, and leveraging the LLM to incorporate relevant external information for generating more precise cypher queries.

13. The system of claim 8, the operations further comprising:
supporting extremely large graphs through iterative filtering, wherein vertex filtering operates on subsets of the extremely large graphs instead of processing an entire schema at once.

14. The system of claim 13, wherein edge filtering is applied to selected node pairs and relationships between the selected node pairs.

15. A computer program product comprising a computer readable storage medium having computer readable program code embodied therewith, wherein the computer readable program code when executed by a processor performs operations, the operations comprising:
querying a very large knowledge graph by using a Large Language Model (LLM) by selecting only relevant nodes and edges in the very large knowledge graph; and
optimizing a knowledge graph schema sent to the LLM to reduce token usage and improve query accuracy, wherein the very large knowledge graph is a knowledge graph that has more than a predetermined number of nodes and edges.

16. The computer program product of claim 15, the operations further comprising:
selecting the relevant nodes from a Horizontally Scalable Knowledge Graph using the LLM, where only node names and attributes are passed to the LLM for efficient node selection and supporting vertex filtering from a very large graph by iterating over subsets of vertices.

17. The computer program product of claim 15, the operations further comprising:
filtering edges between selected nodes in a large graph database, wherein each pair of selected nodes is iteratively analyzed using the LLM to determine relevant edges based on a user query.

18. The computer program product of claim 15, the operations further comprising:
generating cypher queries with selective attribute inclusion, by using a sub-graph derived from filtered nodes and edges to construct graph queries for question interpretation, query generation, and structured analysis.

19. The computer program product of claim 15, the operations further comprising:
enhancing schema linking using external context, and leveraging the LLM to incorporate relevant external information for generating more precise cypher queries.

20. The computer program product of claim 15, the operations further comprising:
supporting extremely large graphs through iterative filtering, wherein vertex filtering operates on subsets of the extremely large graphs instead of processing an entire schema at once.
